(19) United States
(12) Patent Application Publication
(10) Pub. No.: US 2004/0158687 A1
(43) Pub. Date: Aug. 12, 2004

(54) Distributed raid and location independence caching system

(75) Inventor: Qing Yang, Saunderstown, RI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Board of Governors for Higher Education, State of Rhode Island and Providence Plantations, Providence, RI

(21) Appl. No.: 10/693,077

(22) Filed: Oct. 24, 2003

Related U.S. Application Data
(63) Continuation of application No. PCT/US02/14141, filed on May 1, 2002.

(51) Int. Cl. G06F 12/16

(52) U.S. Cl. 711/162; 711/113

(57) ABSTRACT

An information backup system comprises a first computing system including a first local disk that includes a first disk driver. The first computing system also includes first local RAM, a first network interface that is connected to a computer network and includes a first network driver. A first device driver/bridge responsive to communications from the first network driver and the first disk drive writes data to and reads data from the first local RAM. A second computing system also includes second local RAM and a second network interface that is connected to the computer network and includes a second network driver. A second device driver/bridge responsive to communications from the second network driver and the second disk driver writes data to and reads data from the second local RAM.

### CROSS-REFERENCES TO RELATED APPLICATIONS

This application claims priority from provisional application Serial No. 60/287,946 filed May 1, 2001; and from provisional application Serial No. 60/312,471 filed Aug. 15, 2001. Each of these applications are hereby incorporated by reference.

### BACKGROUND OF THE INVENTION

The invention relates to the field of data back-up systems, and in particular to a distributed RAID and location independence caching system.

A company's information assets (data) are critical to the operations of the company. Continuous availability of the data is a necessary. Therefore, backup systems are required to ensure continuous availability of the data in the event of system failure in the primary storage system. The cost in personnel and equipment of recreating lost data can run into hundreds of thousands dollars.

Local hardware replication techniques (e.g., mirrored disks) increase the fault tolerance of a system by keeping a backup copy readily available. To ensure continuous operation even in the presence of catastrophic failures, a backup copy of the primary data is maintained up-to-date at an off-site location. When backup occurs at periodic intervals rather than in real-time, data may be lost (i.e., the data updated since the last backup operation). A problem with conventional remote backup techniques is that they occur at the application program level. In addition, real-time online remote backup is relatively expensive and inefficient.

A storage area network (SAN) is a dedicated storage network in which systems and intelligent subsystems (e.g., primary and secondary) communicate with each other to control and manage the movement and storage of data from a central point. The foundation of a SAN is the hardware on which it is built. The high cost of hardware/software installation and maintenance makes SANs prohibitively expensive for all but the largest businesses.

A private backup network (PBN) is a network designed exclusively for backup traffic. Data management software is required to operate this network. It consequently increases system resource contention at the application level. The backup is not real-time, thus exposing the business to a risk of data loss. This configuration eliminates all backup traffic from the public network at the cost of installing and maintaining a separate network. Use of PBNs in business is limited due to the high cost.

A third known backup technique is database (DB) built-in backup. The increasing business reliance on databases has created greater demand and interest in backup procedure. Most commercial databases have built-in backup functionality. However, export/import utilities and offline backup routines are disruptive, since they lock database and associated structures, making the data inaccessible to all users. Because processing must cease in order to create the backup, this method of course does not provide real-time capabilities. The same is true for remote backup strategies, which add additional overhead to DB performance. While not achieving real-time capabilities the installation of any of these backup scheme is a time consuming and difficult task for the database administrator.

Therefore, there is a need for an improved information back-up system.

### BRIEF SUMMARY OF THE INVENTION

Briefly, according to an aspect of the present invention, an information backup system includes a plurality of computing units, which each combines or bridges a disk I/O host bus adapter card and a network interface card of the computing unit to implement a distributed RAID and global caching.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a block diagram illustration of a distributed information backup system.

FIG. 2 is a block diagram illustration of an alternative embodiment distributed information backup system.

FIG. 3 is a table of simulation test results.

FIG. 4 is a plot of a remote memory hit ratio versus the number of system nodes.

FIG. 5 is a plot of average input/output response times versus the number of system nodes.

FIG. 6 is a plot of system throughput.

### DETAILED DESCRIPTION OF THE INVENTION

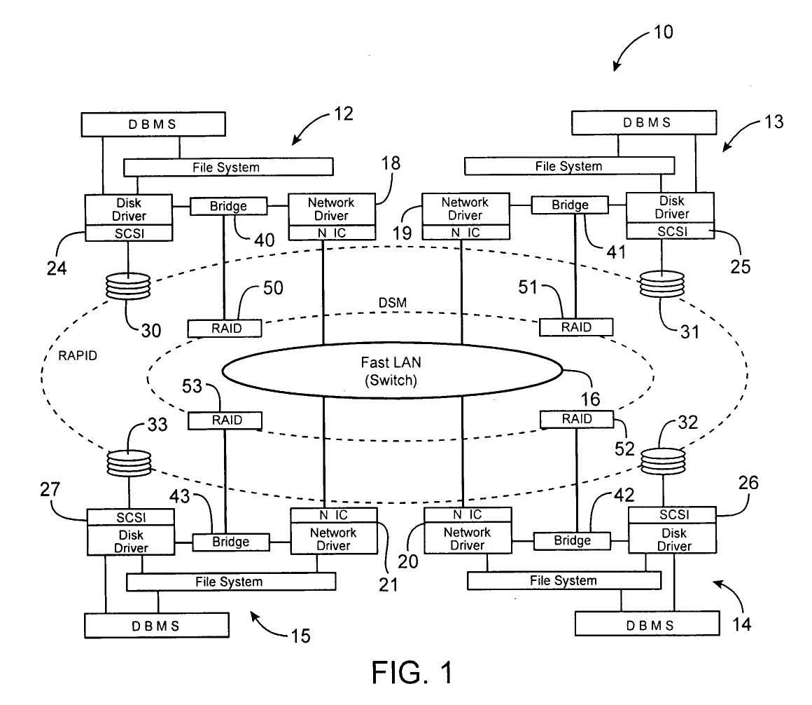

FIG. 1 is a block diagram illustration of an information backup system 10. The system 10 includes a plurality of computing devices 12-15 (e.g., personal computers/workstations) that are interconnected via a packet switched such as for example a local area network (LAN), a wide area network (WAN), etc. Each of the computing devices 12-15 communicates for example with an associated database management system (DBMS) and file system. In this embodiment, each of the computing devices 12-15 includes an associated network interface card (NIC) 18-21, respectively, that handles input/output (I/O) between the associated computing unit and the network 16. Each computing unit 12-15 also includes a disk input/output host bus adapter card 24-27, respectively, which communicates with a disk drive 30-33 of the associated computing unit. The disk drive may include SCSI drive.

Each computing unit 12-15 also includes a device driver/bridge 40-43, which communicates between the disk driver and the network driver of its associated computing unit. Each computing unit 12-15 also includes local RAM 50-53, respectively, which is partitioned into a first section and a second section. The first section of each RAM is controlled by the local operating system (OS) executing in its associated computing unit. The second section of each RAM is controlled by its associated device driver/bridge 40-43. The second sections of the RAMs 50-53 collectively provide a distributed cache. Each device driver/bridge 40-43 handles communications between their associated NIC 18-21 and disk driver 24-27, respectively, to provide a unified system cache for an underlying RAID system.

To provide a distributed RAID, each of the associated local disks 30-33 is partitioned into at least two disk sections. A first disk section contains the local operating system (OS), data and applications, while a second disk section is configured to be part of a RAID system. That is, the device drivers/bridges 40-43 on each computing device cooperate to provide a distributed RAID, which stores information on the second section of the disks 50-53. Each device driver/bridge 40-43 handles communications between their associated NIC 13-21 and disk driver 24-27, respectively.

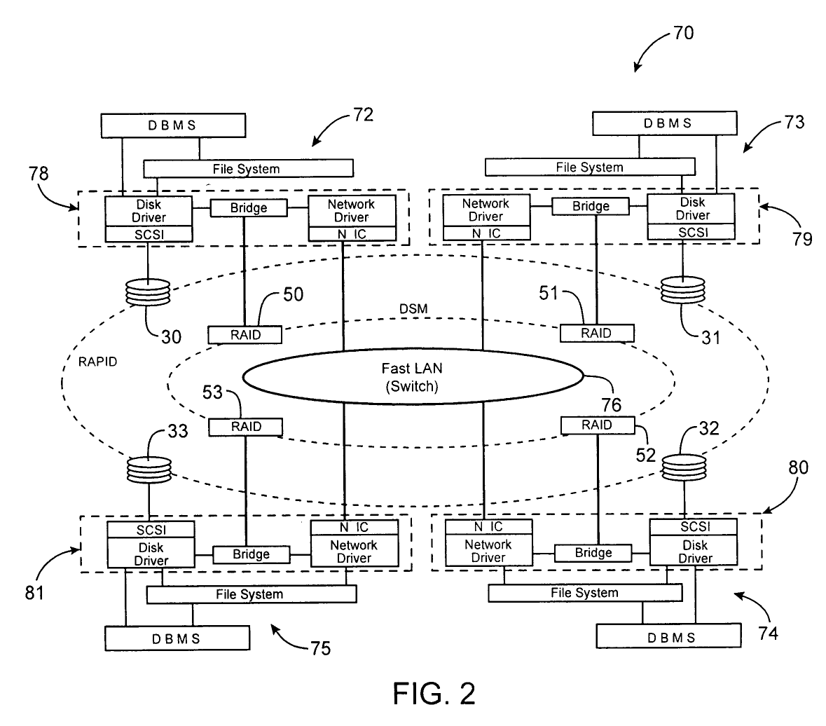

FIG. 2 is a block diagram illustration of an alternative embodiment information backup system 70. The embodiment of FIG. 2 is substantially the same as the embodiment of FIG. 1 with the principal exception that the functions of the NIC, the disk driver and the device driver/bridge are integrated onto a single card/integrated circuit with an embedded processor. Referring to FIG. 2, this system includes a plurality of computing devices 72-75 that are interconnected via a packet switched data network 76. Each of the computing devices 72-75 communicates for example with an associated database management system (DBMS) and a file system. In this embodiment, each of the computing devices 72-75 includes an integrated interface card (IIC) 78-81, respectively, that handles input/output (I/O) between the associated computing unit and the network 16, and also I/O between the computing unit and an associated local disk 84-87. Each disk (e.g., 84) together with the disks in other the computing nodes (e.g., disks 81-83) forms a distributed RAID, which appears to a user as a large and reliable logic disk space.

Besides network access and local disk access, each IIC 78-81 controls the second partition of its associated RAM 50-53. Significantly, the RAM partitions in the computing nodes together form a large, global, and location independence cache for the RAID and is accessible to any node connected to the network, independent of its physical location.

The system of the present invention combines or bridges the disk I/O host bus adapter card and the NIC to implement distributed RAID and global caching. Specifically, FIG. 1 illustrates an embodiment that bridges the disk I/O host bus adapter card and the NIC, while FIG. 2 illustrates an embodiment that combines disk I/O host bus adapter interface and the NIC.

Advantageously, the system of the present invention allows the computing nodes to work together in parallel to process web requests. The distributed RAID allows parallel operations of disk accesses and provides fault tolerance using parity disks, whereas location independence caches provide cooperative caching to the computing nodes for better I/O performance. The system of the present invention also provides a cost-effective architectural approach since it uses relatively low cost PCs/workstations that are often readily available as existing computing facilities in an organization.

A preliminary performance analysis was performed to look at the effects of bus and network delays on the performance potential of the system. A PCI bus can currently run at about 33-132 MHz with data width of 32 or 64 bits. As a result, the memory bandwidth of PCI based system is BWₘₑₘ=33M*32 bits/sec=132 MB/sec. A Gigabit Ethernet switch with the transfer speed up to 1 Gbps can provide network bandwidth of approximately BWₙₑₜ=100 MB/s. The overhead of network operation including both software and hardware is assumed to be OHₙₑₜ=0.2 ms. As for disks, we consider a typical SCSI disk drive such as a UltraStar 18ES, with a capacity of 9.1 GB; an average seek speed of 7.0 ms, a rotational speed of 7200 RPM, an average latency of 4.17 ms and a transfer rate of 187.2-243.7 Mbps.

Based on the above disk parameters, we can assume the typical bandwidth of the disk to be BW_{dsk}=25 MB/s and the overhead of disk to be OH_{dsk}=12 ms. The following lists other notations and formulae used in the analysis:

B: data block size (8 KB);

N: number of nodes within the system;

Hₗₘ: Local memory hit ratio;

Hᵣₘ: Remote memory hit ratio;

Tₗₘ: Local memory access time (second);

Tᵣₘ: Remote memory access time (second);

T_{raid}: access time from the distributed RAID (second);

T_{pc}: ′Average I/O response time of traditional PCs with no cooperative caching (second); and

T_{dralic}: Average I/O response time of the system (second).

As a result the following relationships exist:

$$\begin{matrix}{T}_{lm} = \frac{B}{{BW}_{mem}} & EQ . 1 \\ {T}_{rm} = \frac{B}{{BW}_{net}} + {OH}_{net} + \frac{B}{{BW}_{dsk}} & EQ . 2 \\ {T}_{raid} = \frac{( N - 1 ) B}{N \times {BW}_{net}} + N \times {OH}_{net} + \frac{B}{N \times {BW}_{dsk}} + {OH}_{dsk} & EQ . 3 \\ {T}_{pc} = {OH}_{dsk} + \frac{B}{{BW}_{dsk}} & EQ . 4\end{matrix}$$

T_{dralic}=Hₗₘ×Tₗₘ+(1−Hₗₘ)×Hᵣₘ×Tᵣₘ×(1−Hₗₘ)×(1−Hᵣₘ)×T_{raid} EQ. 5

With lack of measured hit ratios of remote caches, a remote hit ratio was assumed to be a logarithm function of number of nodes in the system as shown in FIG. 4. It is reasonable to assume that the remote cache hit ratio increases with the number of nodes because more nodes give larger cooperative cache spaces. The exact hit ratio is not significant here since the hit ratio is used as a changing parameter to observe I/O performance as a function of it. As shown in FIG. 5, even with a hit ratio of 50%, performance is doubled with two nodes. With a remote hit ratio of 80%, a factor of four (4) performance improvement can be obtained with four nodes.

To demonstrate the feasibility and performance potential of the system, a simulation was performed using a program running on every computing node. In the experiments, four computing nodes running Windows NT were connected through a 100 Mbps switch. Four hard drive partitions, one from each node, were combined into a distributed RAID through the system simulation.

PostMark was used as a benchmark to measure the results. PostMark measures performance in terms of transaction rates in the ephemeral small-file regime by creating a large pool of continually changing files. The file pool is of configurable size. In our tests, PostMark was configured in three different ways: (1) small—1000 initial files and 50000 transactions; (2) medium—20000 initial files and 50000 transactions; and (3) large—20000 initial files and 100000 transactions. Other PostMark remained at their default settings.

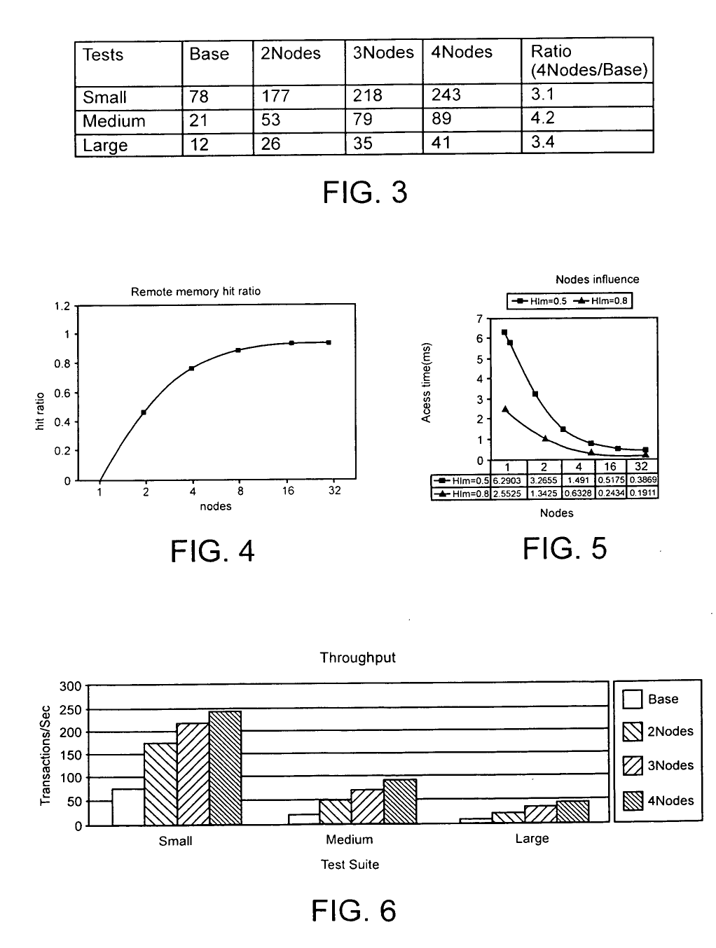

Tests were run with the system configured for two nodes (2 Nodes), three nodes (3Nodes) and four nodes (4Nodes) respectively. These were tested and compared with the results obtained with one node running Windows NT (Base). The results of testing are shown in FIGS. 3 and 6, where larger numbers indicate better performance. With four nodes the performance gain increases to 4.2.

The system of the present invention provides a peer-to-peer direct solution, for example to boost web server performance. The system operates when an actual disk request has come to the system regardless of whether it is a result of a file system miss or a request from a databaséoperation. Advantageously, the system does not require any change to existing operating systems, databases or applications.

Although the present invention has been shown and described with respect to several preferred embodiments thereof, various changes, omissions and additions to the form and detail thereof, may be made therein, without departing from the spirit and scope of the invention.

What is claimed is:

1. An information backup system, comprising:
A. a first computing system including
(i) a first local disk that includes a first disk driver;
(ii) first local RAM;
(iii) a first network interface that is connected to a computer network and includes a first network driver;
(iv) first means responsive to communications from said first network driver and said first disk driver, for writing data to and reading data from said first local RAM;
B. a second computing system including
(i) a second local disk that includes a second disk driver;
(ii) second local RAM;
(iii) a second network interface that is connected to the computer network and includes a second network driver; and
(iv) second means responsive to communications from said second network driver and said second disk driver, for writing data to and reading data from said second local RAM.

2. The information backup system of claim 1, wherein said first means for writing data communicates with said first disk driver to cache data in the first local RAM.
